(19) United States
(12) Patent Application Publication
(10) Pub. No.: US 2013/0112283 A1
(43) Pub. Date: May 9, 2013

(54) Vacuum Connector

(71) Applicant: Yuriy Zakuskin, Orekhov (UA)

(72) Inventor: Yuriy Zakuskin, Orekhov (UA)

(21) Appl. No.: 13/288,028

(22) Filed: Nov. 3, 2011

(51) Int. Cl. G05D 16/00

(52) U.S. Cl. 137/82

(57) ABSTRACT

A connector can include a first portion with a cylindrical end. The connector can also include a second portion having a cylindrical cavity and a plurality of collars disposed along an interior circumference of the cavity and extending inward so as to contact the first portion when the first portion is inserted into the second portion and to create a seal between the cylindrical end and the cylindrical cavity. The connector can further include a pressure equalization channel with an opening toward the cylindrical cavity at one end and a valve disposed at the other end, the valve being configured to have a first position at which the pressure equalization channel is open to an exterior, and a second position at which the pressure equalization channel is sealed.

Embodiments relate generally to connectors and, more particularly, to a vacuum connector.

One embodiment includes a connector with a first portion having a cylindrical end. The connector can also include a second portion having a cylindrical cavity and a plurality of collars disposed along an interior circumference of the cavity and extending inward so as to contact the first portion when the first portion is inserted into the second portion and to create a seal between the cylindrical end and the cylindrical cavity. The connector can further include a pressure equalization channel with an opening toward the cylindrical cavity at one end and a valve disposed at the other end, the valve being configured to have a first position at which the pressure equalization channel is open to an exterior, and a second position at which the pressure equalization channel is sealed.

Another embodiment includes a connector having a first portion having a cylindrical end and a second portion having a cylindrical cavity and a plurality of circular collars disposed along an interior circumference of the cavity and extending inward so as to contact the first portion when the first portion is inserted into the second portion and to create a seal between the cylindrical end and the cylindrical cavity. The second portion can also include a pressure equalization channel with an opening toward the cylindrical cavity at one end and a valve disposed at the other end, the valve being configured to have a first position at which the pressure equalization channel is open to an exterior, and a second position at which the pressure equalization channel is sealed.

Yet another embodiment can include a connector having a first portion having a cylindrical end and a second portion. The second portion can include a cylindrical cavity and a plurality of collars disposed along an interior circumference of the cavity and extending inward so as to contact the first portion when the first portion is inserted into the second portion and to create a seal between the cylindrical end and the cylindrical cavity, the cylindrical cavity including a first section having a first diameter and a second section having a second diameter, the second diameter being larger than the first diameter. The embodiment can also include a pressure equalization channel with an opening toward the cylindrical cavity at one end and a valve disposed at the other end, the valve being configured to have a first position at which the pressure equalization channel is open to an exterior, and a second position at which the pressure equalization channel is sealed.

### BRIEF DESCRIPTION OF THE DRAWINGS

FIG. 1 is a diagram of an exemplary connector in accordance with at least one embodiment.

FIG. 2 is a diagram of an exemplary connector during insertion phase in accordance with at least one embodiment.

FIG. 3 is a diagram of an exemplary embodiment of a connector that has been coupled and sealed, in accordance with at least one embodiment.

FIG. 4 is a diagram of an exemplary connector having a pressure equalization channel disposed in the portion having a cylindrical cavity, in accordance with at least one embodiment.

FIG. 5 is a diagram of an exemplary connector having a pressure equalization channel disposed in the portion having a cylindrical cavity, in accordance with at least one embodiment.

FIG. 6 is a diagram of an exemplary connector having a cylindrical cavity with two sections and prior to the cylindrical end being inserted into the cylindrical cavity, in accordance with at least one embodiment.

FIG. 7 is a diagram of the connector shown in FIG. 5 with the cylindrical end being inserted into the cylindrical cavity, in accordance with at least one embodiment.

### DETAILED DESCRIPTION

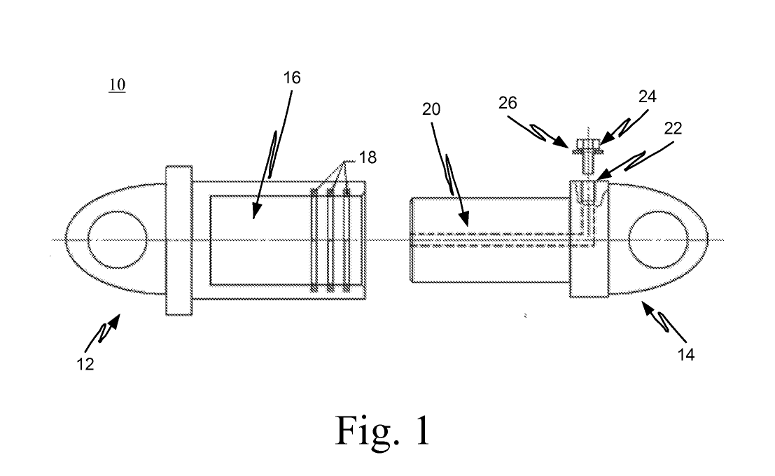

FIG. 1 is a diagram of an exemplary vacuum connector 10. The vacuum connector 10 includes a first member 12 having a cylindrical chamber 16 and a second member 14 having a cylindrical piston 15 configured to fit within the cylindrical chamber of the first portion 12. The first portion 12 also includes one or more collars 18 disposed on an inside surface of the cylindrical chamber 16 and spaced apart from each other. The collars 18 are formed in an annular (or ring) shape and can be formed of a material such as silicone or other soft rubber or plastic material. In general, any material capable of creating a press fit air or water tight seal between the chamber and the piston can be used.

The second portion 14 includes an air vent (or pressure relief) channel 20 that extends through the piston from the end of the piston to an outlet 22 disposed on an outer surface of the second member 14. The outlet 22 being configured to receive a pressure relief stopper 24. The stopper 24 can also include a washer or gasket 26 that can be formed of a pliable material such as rubber or a soft plastic that is capable of creating an air (or water) tight seal between a bottom surface of the stopper 24 and an opening of the outlet 22.

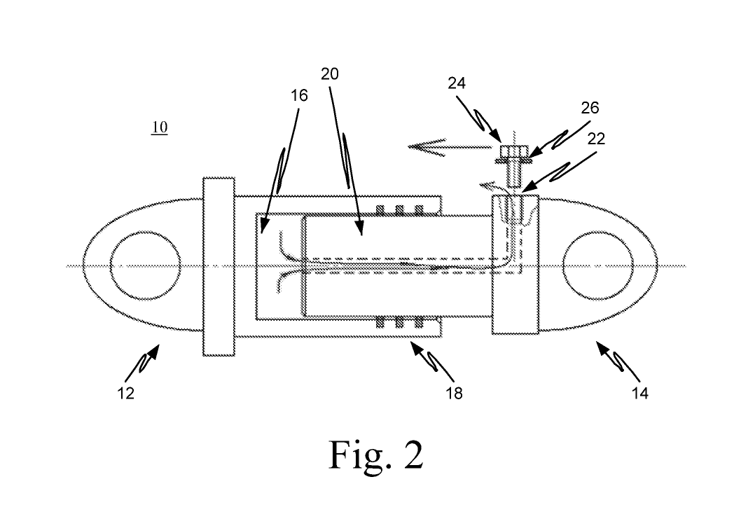

For example, the inside of the outlet 22 can be threaded to receive a threaded stopper 24, such that when the threaded stopper 24 is inserted fully into the outlet 22, no air can pass into or out of the channel 20. And, when the threaded stopper 24 is partially or fully retracted from the outlet 22 air can freely pass through channel 20 so as to let air into or out of chamber 16 as the piston is being withdrawn or inserted from/to the chamber 16, respectively. See, for example, FIG. 2 showing the piston being inserted into the chamber 16 and the air flow through the channel 20 and escaping from the outlet 22. In this way, the air being displaced by the insertion of the piston can be released from the chamber 16.

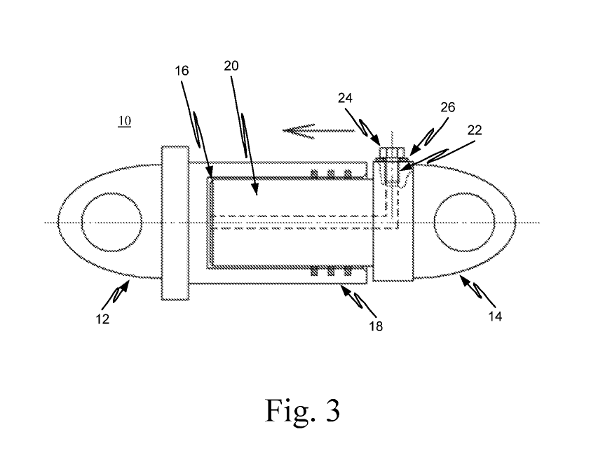

Once the piston has been inserted to a desired depth (either fully or partially inserted) within the chamber 16, the stopper 24 can be inserted into the outlet 22 and secured. Now, when opposing forces (or force) is applied to the first member 12 and second member 14, the piston is held in the chamber 16 via vacuum force created by the collars being in frictional contact with the piston and not allowing an air to pass by. Also, the stopper 24 having been secured in the outlet 22 so as to prevent air from entering the chamber 16 via the channel 20. See, e.g., FIG. 3.

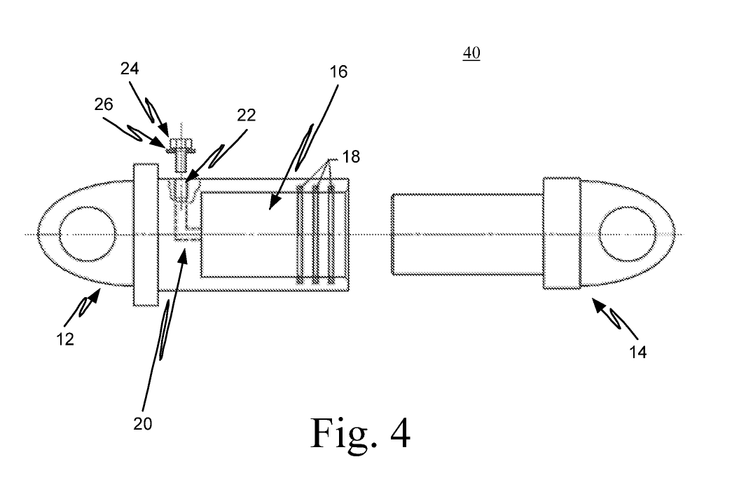

FIG. 4 is a diagram of an exemplary vacuum connector showing another embodiment in which the pressure equalization channel 20 is disposed in the first portion 12 having the cylindrical cavity (or chamber) 16.

The embodiment of FIG. 4 works in essentially the same manner as that shown in FIGS. 1-3, with the exception that the piston of the embodiment of FIG. 4 does not have a channel extending from the end of the piston to an outlet on the second member 14. Instead, in this embodiment, the channel 20 extends from the chamber 16 to an outer surface of the first portion 12. The operation of the stopper 24, gasket 26 and outlet 22 are similar to that described above for FIGS. 1-3.

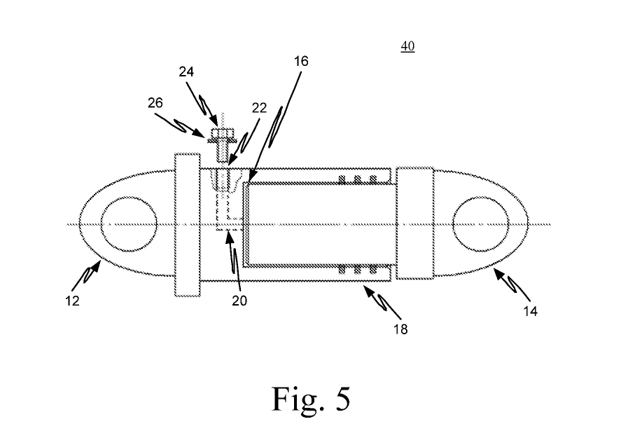

FIG. 5 shows the connector embodiment of FIG. 4, in which the piston of the second portion 14 has been inserted in the cavity 16 of the first portion 12.

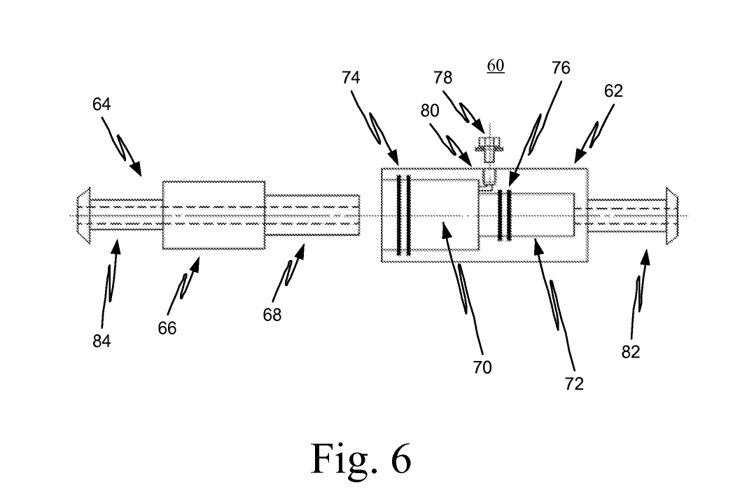

FIG. 6 is a diagram yet another embodiment of a vacuum connector 60. The connector 60 includes a first member 62 having a cylindrical cavity (or chamber) with two sections. A first section 70 of the cavity having a larger diameter than a second section 72.

The first section 70 includes one or more first collars 74 and the second section 72 includes one or more second collars 76. An outlet and channel 80 is connected to the first section 70. A stopper and gasket 78 is configured to be inserted into the outlet 80 to create an air (or water) tight seal.

The connector 60 also includes a second member 64 having a cylindrical piston with a first section 66 and a second section 68. The first section 66 of the piston having a larger diameter than the second section 68.

The first section 66 of the piston is formed to fit frictionally into the first section 70 of the first member 62. The second section 68 of the piston is formed to fit frictionally into the second section 72 of the first member 62.

The general operation of insertion, securing the stopper to close the channel and create a locking vacuum force is similar to that discussed above regarding FIGS. 1-3.

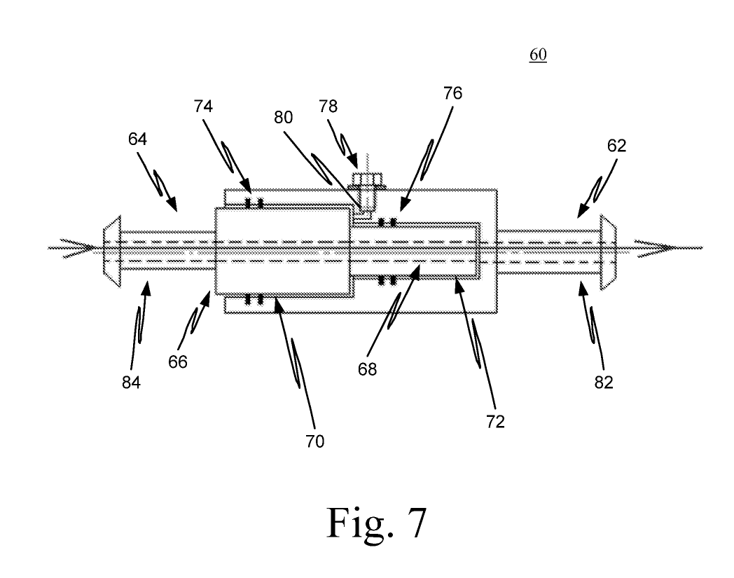

FIG. 7 is a diagram of the connector of FIG. 6 with the second member 64 having been inserted into the first member 62 and the stopper 78 having been inserted into the outlet 80.

Once coupled, the first member and second member of each of the embodiments described above can be rotated with respect to each other in a complete circle.

The connectors described above can be configured and built for a variety of applications including general connectors to couple mechanical objects together, trailer hitches, or the like. It will be appreciated that the ends of the first member and second member, used to couple the connector to other things can be formed according to a contemplated application of the connector.

It is, therefore, apparent that there is provided, in accordance with the various embodiments disclosed herein, a vacuum connector.

While the invention has been described in conjunction with a number of embodiments, it is evident that many alternatives, modifications and variations would be or are apparent to those of ordinary skill in the applicable arts. Accordingly, Applicant intends to embrace all such alternatives, modifications, equivalents and variations that are within the spirit and scope of the invention.

What is claimed is:

1. A connector comprising:
a first portion having a cylindrical end;
a second portion having a cylindrical cavity and a plurality of collars disposed along an interior circumference of the cavity and extending inward so as to contact the first portion when the first portion is inserted into the second portion and to create a seal between the cylindrical end and the cylindrical cavity; and
a pressure equalization channel with an opening toward the cylindrical cavity at one end and a valve disposed at the other end, the valve being configured to have a first position at which the pressure equalization channel is open to an exterior, and a second position at which the pressure equalization channel is sealed.

2. The connector of claim 1, wherein the pressure equalization channel is disposed in the first portion.

3. The connector of claim 1, wherein the pressure equalization channel is disposed in the second portion.

4. The connector of claim 1, wherein the plurality of collars includes three collars.

5. The connector of claim 1, wherein the collars are disposed near an opening of the cylindrical cavity.

6. The connector of claim 1, wherein the cylindrical cavity includes a first section having a first diameter and a second section having a second diameter, the second diameter being larger than the first diameter.

7. The connector of claim 6, wherein the first section has a first plurality of collars disposed therein and the second section has a second plurality of collars disposed therein.

8. The connector of claim 6, wherein the pressure equalization channel opening is disposed in the first section.

9. A connector comprising:
a first portion having a cylindrical end;
a second portion having a cylindrical cavity and a plurality of circular collars disposed along an interior circumference of the cavity and extending inward so as to contact the first portion when the first portion is inserted into the second portion and to create a seal between the cylindrical end and the cylindrical cavity, the second portion also including a pressure equalization channel with an opening toward the cylindrical cavity at one end and a valve disposed at the other end, the valve being configured to have a first position at which the pressure equalization channel is open to an exterior, and a second position at which the pressure equalization channel is sealed.

10. The connector of claim 1, wherein the plurality of collars includes three collars.

11. The connector of claim 1, wherein the collars are disposed near an opening of the cylindrical cavity.

12. A connector comprising:
a first portion having a cylindrical end;
a second portion having a cylindrical cavity and a plurality of collars disposed along an interior circumference of the cavity and extending inward so as to contact the first portion when the first portion is inserted into the second portion and to create a seal between the cylindrical end and the cylindrical cavity, the cylindrical cavity including a first section having a first diameter and a second section having a second diameter, the second diameter being larger than the first diameter; and
a pressure equalization channel with an opening toward the cylindrical cavity at one end and a valve disposed at the other end, the valve being configured to have a first position at which the pressure equalization channel is open to an exterior, and a second position at which the pressure equalization channel is sealed.

13. The connector of claim 12, wherein the first section has a first plurality of collars disposed therein and the second section has a second plurality of collars disposed therein.

14. The connector of claim 12, wherein the pressure equalization channel opening is disposed in the first section.

15. The connector of claim 12, wherein the pressure equalization channel is disposed in the first portion.

16. The connector of claim 12, wherein the pressure equalization channel is disposed in the second portion.

17. The connector of claim 12, wherein the plurality of collars includes three collars.

18. The connector of claim 12, wherein the collars are disposed near an opening of the cylindrical cavity.

19. The connector of claim 12, wherein the first section has a first plurality of collars disposed therein and the second section has a second plurality of collars disposed therein.

20. The connector of claim 12, wherein the pressure equalization channel opening is disposed in the first section.
